(19) United States
(12) Patent Application Publication
(10) Pub. No.: US 2008/0171531 A1
(43) Pub. Date: Jul. 17, 2008

(54) METHOD FOR THE LOCATION-DEPENDENT AND/OR DISTANCE-DEPENDENT BILLING OF COMMUNICATIONS SERVICES IN A MOBILE COMMUNICATIONS NETWORK

(75) Inventors: Gerrit VOHRINGER, Bonn (DE); Arnd THONNES, Alken (DE)

Correspondence Address: THE MAXHAM FIRM, 9330 SCRANTON ROAD, SUITE 350, SAN DIEGO, CA, 92121, US

(73) Assignees: DEUTSCHE TELEKOM AG, Bonn (DE); T-MOBILE INTERNATIONAL AG & CO. KG, Bonn (DE)

(21) Appl. No.: 12/022,053

(22) Filed: Jan. 29, 2008

Related U.S. Application Data
(63) Continuation of application No. PCT/EP2006/007492, filed on Jul. 28, 2006.

(30) Foreign Application Priority Data
Aug. 1, 2005 (DE) 102005036588.4

(51) Int. Cl. H04M 15/00

(52) U.S. Cl. 455/406

(57) ABSTRACT

A method for the location-dependent and/or distance-dependent charging of telecommunication services in a mobile communication network, where the network includes several radio cells, each of which covers a certain service area and is supplied with radio signals by at least one associated base transceiver station. An individual, guaranteed subscriber area describing an area around a predefined geographical location is allocated to a subscriber. An actual subscriber area is formed with which all radio cells or parts of radio cells whose service area overlaps with the guaranteed subscriber area are associated. Telecommunication services used are charged at a special rate when the subscriber is located in the actual subscriber area.

### FIELD OF THE INVENTION

The invention relates to a method for the location-dependent and/or distance-dependent billing of communications services in a mobile communications network.

### DISCUSSION OF PRIOR ART

A requirement for this type of billing in a mobile communications network is that the location of the calling subscriber, and for distance-dependent billing also the location of the called subscriber, must be known with sufficient accuracy.

It is known, and described for example in German patent publication, DE 199 11 938 A1, to perform location-dependent or also distance-dependent billing in mobile wireless networks on the basis of so-called subscriber zones, for example, a home zone. The home zone is an area of a specific size around the home address of a subscriber, and is defined by a geographical home zone coordinate and a home zone radius. This home zone is assigned to certain radio cells. If the distance of the home zone coordinate to the base station of a radio cell currently in use is smaller than the given home zone radius, the radio cell currently in use is regarded as the home zone. Since the physical propagation of the radio signals and thus the areal extent of the radio cell is not taken into consideration, the home zone radius must be selected to be large enough to guarantee that all radio cells in the home zone are also regarded as “belonging to the home zone.” Also accepted in the home zone are cells which are externally emitted by a base station located in the home zone area, that is, cells which do not cover the actual home zone area at all. This is particularly disadvantageous in rural areas, since the home zone is therefore made unnecessarily large.

International patent publication, WO 02/062091 A1, likewise discloses the establishment of an area of a specific size around the home address of a subscriber which is defined by a geographical coordinate and a radius. This area is specified independently from the service areas of radio cells, and has an areal extent that is different from the areal extent of the radio cells A check to determine whether a subscriber is located in this area therefore involves additional complexity, using geographical data.

The technical specification, 3GPP TS 22.071 V7.2.0 (June 2005): 3rd-Generation Partnership Project: Technical Specification Group Services and System Aspects; Location Services (LCS); Service Description; Stage 1 (Release 7), is concerned with location-dependent services in mobile wireless systems. Chapter B2 describes a billing system that is dependent on a location area of the subscriber, whereby the areal extent of the location area is defined independently from the radio cells and may have the shape of a polygon, for example,

### SUMMARY OF THE INVENTION

A purpose of the present invention, therefore, is to provide a method for the location-dependent billing of communications services in a mobile wireless system which allows more accurate allocation of a subscriber zone to radio cells of the mobile wireless network, and which thus allows more accurate billing.

The mobile communications network of an embodiment of the invention comprises multiple radio cells, each radio cell covering a certain service area and being supplied with radio signals by at least one associated base station. An individual, guaranteed subscriber zone describing an area around a predetermined geographical location is allocated to a subscriber. According to the invention, an actual subscriber zone is formed with which all radio cells or portions of radio cells whose service area overlaps with the guaranteed subscriber zone are associated, and telecommunication services used are billed at a special rate when the subscriber is located in the actual subscriber zone.

By simple inclusion of the cell propagation, only the smallest possible number of radio cells are regarded as radio cells belonging to the subscriber zone, resulting in optimum matching of the actual area of the subscriber zone to the area of the desired (guaranteed) subscriber zone.

Before each call setup initiated by a subscriber, by interrogation of a wireless network database a check is made as to whether the connection request is made from a radio cell that is allocated to the actual subscriber zone. If this is the case, a charge assigned to the subscriber zone is applied.

According to one preferred embodiment of the invention, the guaranteed subscriber zone is defined as a polygon which circumscribes the geographical location, and for simplification the service area of a radio cell is approximated by a polygon which circumscribes the service area, whereby results from a radio field prediction are used to determine the circumscribing polygon of a radio cell. To simplify the calculation a rectangle is preferably used as the polygon.

According to embodiments of the invention it is also possible to define multiple, possibly overlapping, subscriber zones for each subscriber. Different rates may then be assigned to the subscriber zones.

The information for defining the subscriber zone of a subscriber is stored in a wireless network database of the mobile wireless system and also in a subscriber identity module for the subscriber.

Embodiments of the invention may preferably be implemented in a network element of the mobile communications network, for example a switching center, in the form of a data processing program containing a process-related program code.

### BRIEF DESCRIPTION OF THE DRAWING

The features, objects, advantages, and applications of the invention will become more evident from the following detailed description, when read in conjunction with the accompanying drawing, wherein:

FIG. 1 schematically shows multiple radio cells of a mobile wireless network for determining according to the invention an actual subscriber zone based on a predetermined guaranteed subscriber zone of a subscriber.

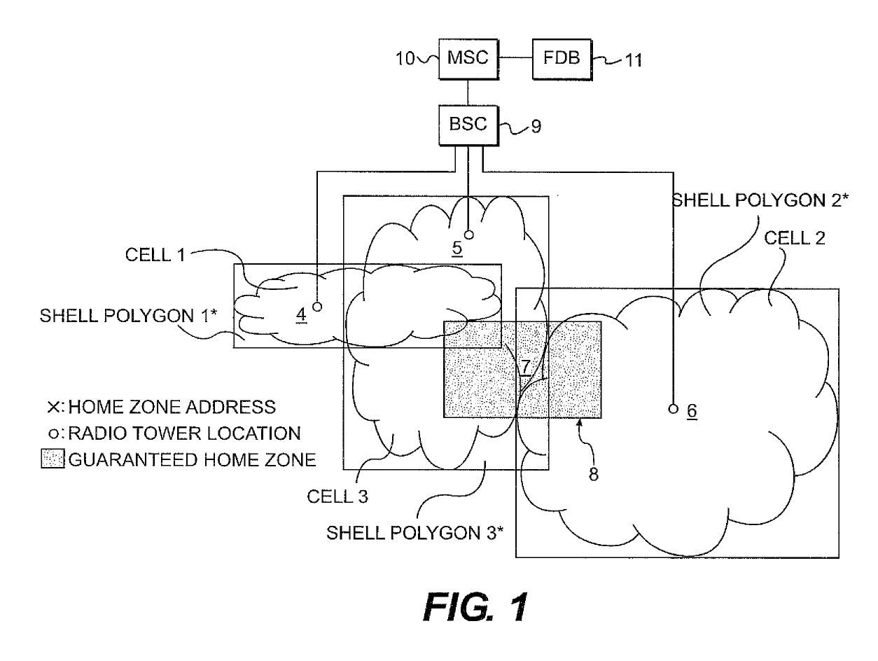

### DETAILED DESCRIPTION OF THE PREFERRED EMBODIMENTS

The mobile wireless network illustrated by way of example comprises multiple radio cells 1, 2, 3, each of which is supplied with radio signals by at least one associated base station 4, 5, 6. The base stations are controlled by a common base station control (BSC) 9, for example, by means of which the base stations are connected via corresponding connecting lines. The base station control in turn is connected to mobile switching center (MSC) 10 which correspondingly establishes a connection with other switching centers and communications networks The mobile switching center has access to wireless network database (FDB) 11 in which, for example, subscriber information and data concerning the structure of the wireless network are stored.

In the exemplary embodiment shown, the method according to this embodiment of the invention is described with reference to the determination of a subscriber zone referred to as a home zone. According to the invention, however, other individual subscriber zones are also possible, such as an office zone, and a location zone, among others.

Home zone 8 of a subscriber is calculated by an evaluation of the wireless network database of the network operator. Starting with a home zone address of a subscriber (street, house number, postal code, city), represented as geographical location 7, an approximately rectangular home zone area 8 is established around this geographical location. This area is referred to as guaranteed home zone 8, and has an areal extent of approximately 500×500 meters, for example. The midpoint of area 8 forms the geographical coordinate of the home zone address. By use of the wireless network database 11, the areal extent of radio cells 1, 2, 3 is evaluated, and a check is made as to whether there are overlaps with guaranteed home zone 8. For simplification, the propagation, that is, the service area, of each radio cell 1, 2, 3 is represented by an associated shell polygon 1*, 2*, 3*, preferably approximately a rectangle, which encloses the entire areal extent of the cell. To calculate the shell polygons 1*, 2*, 3*, the results from a radio field prediction are employed on a cell-by-cell basis within a geoinformation system, using filter algorithms. By taking various propagation models into account, this may be performed for GSM 900/I800 as well as for UMTS networks.

Each radio network cell 1, 2, 3, represented by the associated shell polygon 1*, 2*, 3*, which overlaps with guaranteed home zone 8, is regarded as an actual home zone. The actual home zone thus covers at least the entire surface of guaranteed home zone 8, but is significantly larger than the guaranteed home zone since, in addition, other areas outside the guaranteed home zone are covered.

Before each call setup, the “intelligent network (IN),” for example, switching center 10 or a network element associated with the switching center, such as a services control node, by interrogation of wireless network database 1, checks as to whether the connection request is made from a cell 1, 2, or 3 that is allocated to the actual home zone of the subscriber. If this is the case, the IN system writes this information into the billing ticket, which in the postprocessing systems is then provided with a special (more favorable) home zone rate and is written to the invoice for the subscriber.

Furthermore, it is possible to determine not only whether the calling subscriber is located in his home zone, but also to determine the position of the called subscriber and his distance from the caller. For example, the radio cell in which the called subscriber is located at that moment, that is, the area code of the called subscriber, may be determined. As a result, location-dependent billing may then be performed.

It will be appreciated that modifications and improvements will occur to those skilled in this technical field, which are within the scope of the invention shown by means of a specific embodiment. The invention is to be limited only as defined by the accompanying claims and their equivalents.

What is claimed is:

1. A method for the location-dependent and/or distance-dependent billing of telecommunications services in a mobile communications network comprising multiple radio cells, each radio cell covering a certain service area and being supplied with radio signals by at least one associated base station, the method comprising:
allocating to a subscriber of the mobile communications network an individual, guaranteed home zone defining an area around a predefined geographical location;
defining the guaranteed home zone as a polygon which circumscribes the geographical location; and
forming an actual home zone with which all radio cells whose service area overlaps with the guaranteed home zone are associated, whereby for simplification the service area of a radio cell is approximated by a polygon which circumscribes the service area; and
billing at a special rate the telecommunications services used by the subscriber when the subscriber is located in said actual home zone.

2. The method according to claim 1, and further comprising:
checking before each call setup initiated by a subscriber, by interrogation of a wireless network database, as to whether the connection request is made from a radio cell that is allocated to the actual home zone; and
if this is the case, applying a charge assigned to the home zone.

3. The method according to claim 1, wherein the polygon is approximately a rectangle.

4. The method according to claim 2, wherein the polygon is approximately a rectangle.

5. The method according to claim 1, and further comprising using results from a radio field prediction to determine the circumscribing polygon of a radio cell.

6. The method according to claim 2, and further comprising using results from a radio field prediction to determine the circumscribing polygon of a radio cell.

7. The method according to claim 1, and further comprising defining multiple subscriber zones for each subscriber.

8. The method according to claim 2, and further comprising defining multiple subscriber zones for each subscriber.

9. The method according to claim 7, wherein the multiple subscriber zones of a subscriber overlap.

10. The method according to claim 8, wherein the multiple subscriber zones of a subscriber overlap.

11. The method according to claim 7, and further comprising assigning an individual rate to each subscriber zone.

12. The method according to claim 9, and further comprising assigning an individual rate to each subscriber zone.

13. The method according to claim 1, and further comprising storing information for defining the subscriber zone of a subscriber in a wireless network database of the mobile wireless system.

14. The method according to claim 2, and further comprising storing information for defining the subscriber zone of a subscriber in a wireless network database of the mobile wireless system.

15. The method according to claim 1, and further comprising storing information for defining the subscriber zone of a subscriber in a subscriber identity module for the subscriber.

16. The method according to claim 2, and further comprising storing information for defining the subscriber zone of a subscriber in a subscriber identity module for the subscriber.

17. A data processing program containing a program code which when executed on a data processing device carries out a method according to claim 1.

18. A data processing program product containing a program code which may be executed on a data processing device for carrying out the method according to claim 1.
